(19) United States
(12) Patent Application Publication
(10) Pub. No.: US 2010/0293211 A1
(43) Pub. Date: Nov. 18, 2010

(54) APPARATUS AND METHOD FOR GENERATING MEAN VALUE

(75) Inventors: Seong Chul Cho, Daejeon (KR); Hyung Jin Kim, Daejeon (KR); Gweon Do Jo, Daejeon (KR); Jin Up Kim, Daejeon (KR); Dae Sik Kim, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/517,907

(22) PCT Filed: Jul. 4, 2007
(86) PCT No.: PCT/KR2007/003243

§ 371 Date: Jun. 5, 2009

(30) Foreign Application Priority Data
Dec. 7, 2006 (KR) 10-2006-0124182
Mar. 30, 2007 (KR) 10-2007-0031691

(51) Int. Cl. G06F 7/44; G06F 5/01; G06F 7/42

(52) U.S. Cl. 708/209; 708/445

(57) ABSTRACT

There is provided an apparatus for generating a mean value of N-bit input data in M-bit operations (M and N are integers, and M is greater than N) by dividing a total sum of the input data by number of times the data are input, including a ROM (Read Only Memory) storing therein, as denominators, quotients of dividing 2^{M-N} by integers in a range from one to a maximum allowable number of times for data input. Further, ROM addresses of the denominators are determined based on the integers.

### TECHNICAL FIELD

The present invention relates to an apparatus and a method for generating a mean value of N-bit input data rapidly in M-bit operation; and, more particularly, to an apparatus and a method that are capable of rapidly computing a mean value while minimizing a quantization error in division operation by storing, as denominators, quotients of dividing 2^{M-N} by integers in a range from one to a maximum allowable number of times the data are input at proper addresses in a ROM and using the denominators for obtaining the mean value.

### BACKGROUND ART

FIG. 1 is a block diagram illustrating a conventional divider.

As shown in FIG. 1, a conventional divider has a ROM 101, a multiplier 102 and a rounding unit 103. The ROM 101 stores a reciprocal number of an input denominator, i.e., a value represented by a decimal fraction, and outputs a value stored at a ROM address obtained by using the input denominator. The output value of the ROM is multiplied by an input numerator in the multiplier 102 and then the multiplication result is sent to the rounding unit 103. The rounding unit 103 rounds the output value of the multiplier 102 to disregard extended decimals of input values of the ROM 101 and outputs only a quotient.

For example, in a divider performing division operations on a 12-bit numerator and a 6-bit denominator, the ROM in the divider is required to store sixty-four number of words and a precision thereof can be set arbitrarily to obtain desired performance in consideration of a quantization error.

In the divider, the error depends on the size of the ROM, i.e., the bit number of a denominator. To be specific, storing the reciprocal number of the denominator with insufficient number of bits of a word increase the quantization error due to a limit on increasing the number of the decimal places of a value stored in the ROM 101. Further, it is difficult to obtain a mean value of several input values by using the conventional divider.

### DISCLOSURE OF INVENTION

### Technical Problem

It is, therefore, an object of the present invention to provide an apparatus for generating a mean-value, which is capable of increasing the accuracy of division operation by reducing a quantization error.

Another object of the present invention is to provide a method for generating a mean value using the apparatus for generating a mean value.

### Technical Solution

In accordance with an aspect of the present invention, there is provided an apparatus for generating a mean value of N-bit input data in M-bit operations (M and N are integers, and M is greater than N) by dividing a total sum of the input data by number of times the data are input, the apparatus including: a ROM (Read Only Memory) storing therein, as denominators, quotients of dividing 2^{M-N} by integers in a range from one to a maximum allowable number of times for data input, wherein ROM addresses of the denominators are determined based on the integers.

It is preferable that the device further including: a counter for counting the number of times the data are input; an adder for performing an addition operation at each time the data are input to obtain, as a numerator, the total sum of the input data; an address generator for receiving the number of times the data are input from the counter to generate an address based thereon and retrieving from the ROM one of the denominators whose ROM address matches the generated address; a multiplier for receiving the numerator from the adder and the retrieved denominator from the address generator, to perform a multiplication operation of the numerator and the retrieved denominator; and a rounding unit for rounding a result of the multiplication operation to generate the mean value.

Further, the rounding unit may perform a shift-right operation by M-N-1 bits on the result of the multiplication, and then, if the lease significant bit of a result of the shift-right operation is “1”, add one to the result of the shift-right operation and performs a shift-right operation by one bit to generate the mean value.

Further, the rounding unit may perform a shift-right operation by one bit to generate the mean value if the least significant bit of the result of the shift-right operation is “0”.

In accordance with an another aspect of the present invention, there is provided a method for generating a mean value of N-bit input data in M-bit operations (M and N are integers, and M is greater than N) by using a ROM (Read Only Memory) storing therein, as denominators, quotients of dividing 2M-N by integers in a range from one to a maximum allowable number of times for data input, wherein ROM addresses of the denominators are determined based on the integers. Here, the method including: counting number of times the data are input; performing an addition operation at each time the data are input to obtain, as a numerator, total sum of the input data; generating an ROM address based on the number of times the data are input; retrieving from the ROM one of the denominators whose ROM address matches the generated address; performing a multiplication operation of the numerator and the retrieved denominator; and rounding off a result of the multiplication operation to generate the mean value.

It is preferable that the step of rounding off includes: performing a shift-right operation by M-n-1 bits on the result of the multiplication operation; adding one to a result of the shift-right operation if the least significant bit of the result of the shift-right operation is “1”; and performing the shift-right operation by one bit to generated the mean value.

### BRIEF DESCRIPTION OF THE DRAWINGS

The above and other objects and features of the present invention will become apparent from the following description of embodiments given in conjunction with the accompanying drawings, in which:

FIG. 1 is a block diagram illustrating a conventional divider;

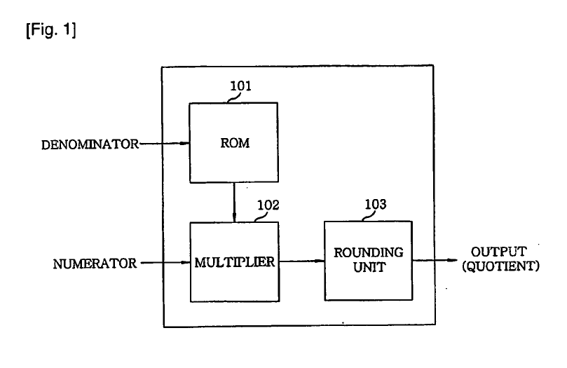

FIG. 2 is a block diagram showing an apparatus for generating a mean value in accordance with an embodiment of the present invention; and

FIG. 3 is a flowchart showing a method for generating a mean value by using a ROM.

### BEST MODE FOR CARRYING OUT THE INVENTION

Hereinafter, embodiments of the present invention will be described in detail with reference to the accompanying drawings. The present invention may be modified in various ways within the technical idea of the present invention, and is not limited to the embodiment as described hereto.

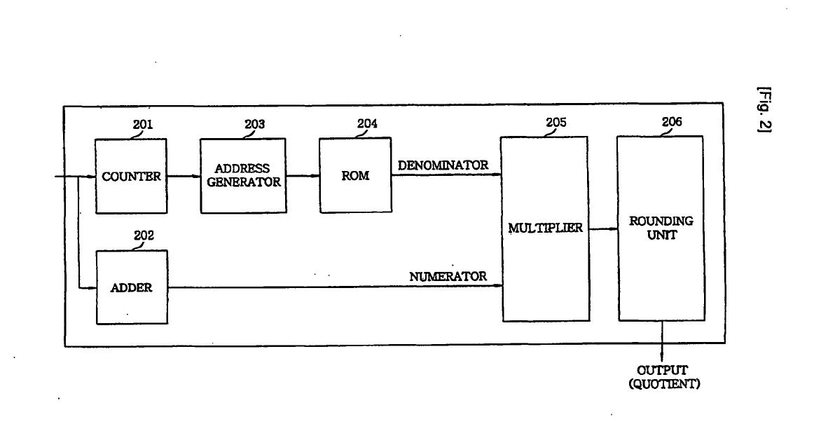

FIG. 2 shows an apparatus for generating a mean value in accordance with an embodiment of the present invention. The apparatus for generating a mean value includes a counter 201, an adder 202, an address generator 203, a ROM 204, a multiplier 205, and a rounding unit 206.

As shown in FIG. 2, the ROM stores therein, as denominators, quotients of dividing the specific value by integers in a range from one to a maximum allowable number of times the data input in order to reduce a quantization error. The specific value refers to a value obtained by dividing an operation bit number by an input data bit number. That is, if input data has N bits in M-bit operation, the specific value is 2M-N. For example, in 16-bit operation if encoded input data has 7 bits, the specific value is 29, i.e., 512, which is obtained by dividing 216 by 27.

The ROM 204 stores, as denominators, quotients of dividing the value 512 by integers in a range from one to a maximum allowable number of times the data are input, at respective ROM addresses matching the integers. For example, if a maximum allowable number of times the data input is “5”, the ROM stores 512 at the first address, stores 256 obtained by dividing 512 by 2 at the second address, stores 170 which is an integer part of the value obtained by dividing 512 by 3 at the third address, stores 128 obtained by dividing 512 by 4 at the fourth address, and stores 102 which is an integer part of the value obtained by dividing 512 by 5 at the fifth address.

The counter 201 counts the number of times the data are input to calculate a mean-value, and generates the counted number to the address generator 203. For example, if there have been five data input times, the counter outputs a value, 5.

The adder 202 performs an addition operation at each time the data are input which, in turn, obtains as a numerator, the total sum of the input data, and sends the result of the addition operation to the multiplier 205. For example, in the present embodiment, the five input data are added and the total sum value of the five input data values is sent to the multiplier 205.

The address generator 203 receives the output of the counter 201 and sends the same to the ROM 204. It then reads a value from the ROM address matching to the output of the counter 201 to send the read value to the multiplier 205. For example, in the present embodiment, the address generator 203 generates an address of the ROM 204 corresponding to the output 5 of the counter 201 to read 102 from the ROM 204, and sends the same to the multiplier 205.

The multiplier 205 receives the numerator from the adder 202 and the retrieved denominator from the address generator 203 and multiplies the numerator and the retrieved denominator to send the result value of the multiplication to the rounding unit 206. For example, in the present embodiment, the output of the adder 202 is multiplied by 102 and the result value of the multiplication is sent to the rounding unit 206.

The rounding unit 206 is configured to both discard bits extended in the ROM 204 and round off. The shift-right operation should be performed by extended in the ROM 204, (M-N) bits. Therefore, the shift-right operation is performed on by (M-N-1) bits and the least significant bit is recognized for the round-off. If the least significant bit is 0, the shift-right operation is further performed by one bit. If the least significant bit is 1, one is added to a result of the shift-right operation and then the shift-right operation is performed by one bit. Thereafter, the result is generated as the division result. For example, in the present embodiment, since M is 16 and N is 7, the input of the rounding unit 206 is shifted by 16-7-1, i.e., 8 bits to the right and the least significant bit is recognized to determine whether 1 should be added or not. If the least significant bit is 0, the shifted input of the rounding unit 206 remains same, and if the least significant bit is 1, a value 1 is added to the shifted input of the rounding unit 206. From there, the shifted input of the rounding unit 206 is further shifted by one bit to the right to be output.

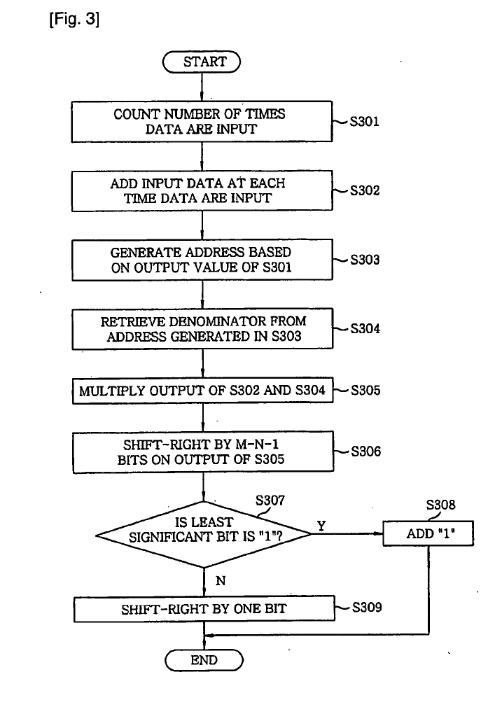

A method for generating a mean value using the ROM will now be described in detail with reference to FIG. 3.

FIG. 3 is a flowchart illustrating a method for outputting a mean value of N-bit input data in M-bit operations (M and N are integers, and M is greater than N) by using a ROM (Read Only Memory). Each step of the method will be described with reference to FIG. 3.

Number of times the data are input is counted and the result of the counting is sent for an address generation (Step S301).

An addition operation is performed on the input data each time the data are input, and a result of the addition operation, as a numerator, is sent to be multiplied (Step S302).

A ROM address is generated based on the result of the count in the step S301 (Step S303). The result of the counting in step S301 is sent to the ROM 204. In this case, the ROM 204 stores therein values obtained by dividing an extended bit number 2M-N of n-bit input data in M-bit operations, by integers in a range from one to a maximum allowable number of times for data input. The denominator is retrieved from the ROM 204 address generated in the step S303 and sent for multiplication (Step S304).

The numerator and the denominator received from the steps S2 and S4 respectively, are multiplied (Step S305).

A shift-right operation is performed by M-N-1 bits on the result of the multiplication in order to round off (Step S306).

Whether the least significant bit is “1” is recognized. If the least significant bit is “1”, one is added to the result of the shift-right operation in the step S306. If the least significant bit is “0”, the result of the shift-right operation remains same (Steps S307 and S308).

Then, the shift-right operation is performed by one bit thereon and the result is generated as a mean value. (Step S309)

As described above, the present invention is configured such that when generating the mean value using the apparatus according to the present invention, the specific bit-extended values are pre-stored in ROM to be applied in the multiplier and the rounding unit performs rounding passing through a stage of determining the round-off.

According to the present invention, the specific bit-extended values is pre-stored in the ROM to be applied in the multiplier, and the rounding unit performs rounding passing through a step of determining the round-off, thereby minimizing a quantization error in the operation. Further, not only the simple shift operation is performed for having a minimized quantization error but also the round-off can be determined just through recognizing whether the least significant bit is “0”, thereby achieving high operational speed. Furthermore, since the ROM does not have to store huge values in order to reduce quantization error, the storage size of the ROM can be reduced.

While the invention has been shown and described with respect to the embodiments, it will be understood by those skilled in the art that various changes and modifications may be made without departing from the scope of the invention as defined in the following claims.

1. An apparatus for generating a mean value of N-bit input data in M-bit operations (M and N are integers, and M is greater than N) by dividing a total sum of the input data by number of times the data are input, the apparatus comprising:
a ROM (Read Only Memory) storing therein, as denominators, quotients of dividing 2^{m-N} by integers in a range from one to a maximum allowable number of times for data input, wherein ROM addresses of the denominators are determined based on the integers.

2. The apparatus of claim 1, further comprising:
a counter for counting the number of times the data are input;
an adder for performing an addition operation at each time the data are input to obtain, as a numerator, the total sum of the input data;
an address generator for receiving the number of times the data are input from the counter to generate an address based thereon and retrieving from the ROM one of the denominators whose ROM address matches the generated address;
a multiplier for receiving the numerator from the adder and the retrieved denominator from the address generator, to perform a multiplication operation of the numerator and the retrieved denominator; and
a rounding unit for rounding a result of the multiplication operation to generate the mean value.

3. The apparatus of claim 2, wherein the rounding unit performs a shift-right operation by M-N-1 bits on the result of the multiplication, and then, if the lease significant bit of a result of the shift-right operation is “1”, add one to the result of the shift-right operation and performs a shift-right operation by one bit to generate the mean value.

4. The apparatus of claim 3, wherein, the rounding unit performs a shift-right operation by one bit to generate the mean value if the least significant bit of a result of the shift-right operation is “0”.

5. A method for generating a mean value of N-bit input data in M-bit operations (M and N are integers, and M is greater than N) by using a ROM (Read Only Memory) storing therein, as denominators, quotients of dividing 2^{M-N} by integers in a range from one to a maximum allowable number of times for data input, wherein ROM addresses of the denominators are determined based on the integers, the method comprising of:
counting number of times the data are input;
performing an addition operation at each time the data are input to obtain, as a numerator, total sum of the input data;
generating an ROM address based on the number of times the data are input;
retrieving from the ROM one of the denominators whose ROM address matches the generated address;
performing a multiplication operation of the numerator and the retrieved denominator; and
rounding a result of the multiplication in the step (e) to generate the mean value.

6. The method of claim 5, wherein the step of rounding includes:
performing a shift-right operation by M-N-1 bits on the result of the multiplication operation;
adding one to a result of the shift-right operation if the least significant bit of the result of the shift-right operation is “1”; and
performing the shift-right operation by one bit to generated the mean value.
